(19) United States
(12) Patent Application Publication
(10) Pub. No.: US 2026/0266393 A1
(43) Pub. Date: Sep. 10, 2026

(54) VALVE UNIT

(71) Applicant: Eugen Seitz AG, Wetzikon (CH)

(72) Inventors: Manuel KEEL, Wildegg (CH); Marco ERNI, Schongau (CH)

(73) Assignee: Eugen Seitz AG, Wetzikon (CH)

(21) Appl. No.: 18/873,514

(22) PCT Filed: Jun. 15, 2023
(86) PCT No.: PCT/EP2023/066139

§ 371 Date: Dec. 10, 2024

(30) Foreign Application Priority Data
Jun. 17, 2022 (EP) 22179550.3

(51) Int. Cl. F16K 37/00

(52) U.S. Cl. CPC F16K 37/0041

(57) ABSTRACT

A valve unit having a valve having a movable piston for closing and opening the valve. The valve unit also having a magnet or a magnetizable element and a sensor unit which has a magnetic field sensor, preferably a Hall effect sensor, for determining a position of the piston. The magnet or the magnetizable element and the sensor unit can be moved relative to each other by the movement of the piston. The valve unit has a control device which continuously evaluates positions of the piston. The control device is designed to evaluate, in addition to a closed state and an open state of the valve, additional positions during a movement of the piston. The valve unit allows precise monitoring of the piston and thus early detection of aging.

### TECHNICAL FIELD

The present invention relates to a valve unit, in particular for pneumatic switching in a blow-moulding process. The valve unit is suitable in particular for use in an extrusion-blow-moulding or a stretch-blow-moulding machine for manufacturing hollow bodies composed of plastic. It is also suitable for gas applications, especially for fluid supply systems, for example for hydrogen fuel stations.

### PRIOR ART

Blow-moulding apparatuses or blow-moulding machines are used to form hollow bodies, in particular for production of plastics bottles composed of PP (polypropylene) or PET (polyethylene terephthalate). Normally, a preform, the temperature of which has been controlled in advance, is connected to a blowing nozzle of the blow-moulding machine. Said preform is widened by blowing a process gas, preferably compressed air, into it. Using blow moulding makes it possible to obtain the desired shape.

The production or formation of such hollow bodies by means of blow-moulding machines is effected within a few seconds, preferably within 1 to 3 s, the process gas being blown in over two or more stages. The individual blow-moulding steps such as the venting are controlled by means of valves. High requirements are therefore placed on these valves. They have to be able to switch as precisely and rapidly as possible and their response times also have to be as short as possible. Use is normally made of process valves which comprise a pneumatically actuated main valve and at least one associated pilot valve for controlling the main valve. The main valve preferably comprises a piston which is pressure-balanced with respect to the process gas and which is actuated merely by means of the control pressures applied via the at least one pilot valve.

EP 1 574 771 A2, EP 2 142 830 B1, EP 3 530 431 A1 and WO 2019/105783 A1 disclose such main valves which are pilot-controlled by means of pilot valves.

Process valves are exposed to high loadings and are subject to an ageing process. They therefore have to be replaced regularly in order to ensure a constantly optimal switching behaviour of the blow-moulding machine.

Furthermore, there is a range of uncertainty regarding the time at which the piston switches. It is not known exactly when the piston switches. This results in additional reserves being provided in the blow-moulding process. By way of example, pauses between valve opening phases are incorporated.

Furthermore, hollow bodies, in particular bottles, are increasingly being produced with relatively thin walls and/or with a proportion of recycled PET. Recycled PET exhibits material inhomogeneity, which reacts sensitively to deviations from the ideal blow-moulding process. Thin walls also place higher requirements on the reproducibility of the blow-moulding process, in order for individual bottles to not burst.

Valves therefore have to be exchanged at an early stage, i.e. before their quality in terms of switching behaviour decreases. The reserves and tolerances to be taken into account have the effect that the blow-moulding process cannot be completely optimized either in terms of time or with regard to the process pressure used. The result of these restrictions is thus that the production process is not yet completely optimized in terms of costs.

DE 37 30 940 A1 discloses a pilot-controlled directional valve with a movable piston, the position of which is measured by means of a Hall sensor. A permanent magnet is arranged centrally in the piston. The Hall sensor is located in an intermediate plate between a pilot control means and a valve housing in a positionally fixed manner. The intermediate plate requires space and makes it difficult to exchange the valve.

DE 44 17 464 A1 discloses a valve comprising a spool member which is actuated by a pilot part and comprising a Hall sensor which detects the movement tendency of the spool member in order to determine whether the spool member is not adhering.

CN 103148222 A describes a hydraulic control valve comprising an electromagnetic pilot valve and a Hall sensor.

The monitoring of a pilot-controlled pneumatic valve employed in blow-moulding processes is complex, not least due to the minimal space availability and the regulatory provisions for the production of hollow bodies in the food sector, for example of PET drink bottles.

### SUMMARY OF THE INVENTION

It is therefore an object of the invention to provide a valve unit, in particular for pneumatic switching in a blow-moulding process, the switching behaviour of which can be monitored and which can nevertheless be exchanged in a simple manner.

In preferred embodiments, the valve unit according to the invention comprises
a valve which comprises a movable piston for closing and opening the valve,
a magnet or a magnetizable element and
a sensor unit comprising a magnetic field sensor, preferably a Hall sensor, for determining a position of the piston.

The magnet or the magnetizable element and the sensor unit are movable relative to one another by the movement of the piston. The valve unit comprises a control device which continuously evaluates positions of the piston, wherein the control device is configured to evaluate further positions during a movement of the piston in addition to a closed and an open state of the valve.

The use of a magnetic field sensor allows the valve unit to be designed in such a way that allows an easy replacement, but the switching behaviour can be optimally monitored thanks to continuous evaluation. This valve unit makes it possible to observe the behavior of the piston during the entire closing and opening operation. Wear can be identified more rapidly and the optimal time for exchanging the piston or the entire valve can be determined more effectively.

Sensor values are recorded in short intervals, wherein not only the end positions of the piston is evaluated by the control unit, but also intermediate positions.

The invention also relates to a valve unit comprising
a valve which comprises a movable piston for closing and opening the valve,
a magnet or a magnetizable element and
a sensor unit comprising a magnetic field sensor for determining a position of the piston.

The magnet or the magnetizable element and the sensor unit are movable relative to one another by the movement of the piston. The sensor unit is arranged in a receiving opening in the valve unit, said receiving opening being of closed configuration in relation to a space into which the piston penetrates during its movement.

By virtue of the arrangement of the sensor unit in a receiving opening which is closed towards the piston, special sealing of pressure space and measurement arrangement is unnecessary. Furthermore, the mounting of the sensor unit into the receiving opening is relatively simple. The use of a magnetic field sensor, in particular a Hall sensor, also allows relatively precise measurement of the piston position.

The magnetic field sensor is preferably a Hall sensor, a magneto-resistive sensor or another magnetic field sensor having similarly small dimensions as the two first-mentioned sensors. The magnetic field sensor is preferably a Hall sensor.

In preferred embodiments, the receiving opening is in the form of a blind bore, with the result that the component forms, together with the receiving opening itself, a wall between the sensor unit and the piston. In other embodiments, the receiving opening is in the form of a through-bore, wherein the opening facing towards the piston is closed by suitable means, for example by means of a stopper or a casting composition.

If the space between the sensor unit and the piston is accessible to the process fluid of a blow-moulding device, the corresponding component is preferably of one-part configuration and forms the separating wall between the sensor unit and the piston. This ensures that the process fluid, normally compressed air, cannot be contaminated, such that regulations which apply to the production of drink bottles are met.

In preferred embodiments, the magnet is a permanent magnet. The permanent magnet is preferably manufactured from a hard magnetic material. In other embodiments, the magnet is an electromagnet.

The magnetizable element is preferably manufactured from a soft magnetic material, and even more preferably from a magnetically conductive material with low remanence, and even more preferably from a magnetically conductive material with very low remanence.

Preferably, the magnet or the magnetizable element is arranged in the piston and the sensor unit is arranged in a positionally fixed manner. This facilitates the mounting of the sensor unit and permits a cable connection from the sensor unit to a control device. Furthermore, the piston can be produced in a cost-effective manner.

If the magnetizable element is arranged in the piston, an associated magnet, in particular a permanent magnet or an electromagnet, is preferably arranged in a positionally fixed manner, preferably adjacent to the sensor unit.

Preferably, the sensor unit is arranged in a housing part of the valve unit, wherein the receiving opening is of open configuration towards an outer side for the purpose of introducing the sensor unit. This facilitates the mounting and an exchanging of the sensor unit. Furthermore, it is advantageous for the sensor unit to be in the existing housing of the valve unit. This is advantageous in particular in the case of blow-moulding devices with their valve blocks, since the available space is already low and therefore any additional component is preferably avoided.

In preferred embodiments, the magnetic field sensor, in particular the Hall sensor, and the magnet or the magnetizable element are arranged spaced apart from one another along a common axis, wherein the common axis extends along the movement direction of the piston during the opening and closing of the valve. This facilitates the orienting of the sensor unit and of the associated magnet or of the associated magnetizable element with respect one another. Furthermore, the measurement and the evaluation of the data are facilitated.

Preferably, the receiving opening has a longitudinal direction which extends along the common axis. As a result, the sensor unit can be arranged in the valve unit in a space-saving manner. The total size of the valve unit can remain unchanged as a result.

The magnet can be of relatively small form, in particular in the case of an arrangement of the sensor unit and of the magnet along a common axis. As a result, the space requirement is minimized and the valve unit is not made larger by the measuring device. In other embodiments, the magnet or the magnetizable element consists of a plurality of parts. By way of example, two magnets can be arranged next to one another.

The magnet is preferably in the form of a flat bar magnet or a ring magnet. Preferably, the bar magnet is arranged centrally and along a diagonal in a cylindrical base body of the piston, said bar magnet preferably running perpendicular to the movement direction of the piston. The ring magnet is preferably arranged centrally in the piston. Preferably, the magnet is arranged in such a way that the magnetic field lines perpendicularly cross the movement direction of the piston.

The magnetizable element is preferably manufactured from a ferromagnetic material. If a magnetizable element is used, a magnet is preferably also present, preferably in the form of a permanent magnet or an electromagnet. This magnet is preferably arranged in a positionally fixed manner with respect to the sensor unit. As a result, the piston, which is a consumable and has to be exchanged regularly, can be produced in a cost-effective manner. The permanent magnet or the electromagnet and the sensor unit can thus be used for longer than the piston.

The magnetic field sensor, in particular the Hall sensor, may be a one-dimensional (1D) sensor. However, a precise measurement using a 1D sensor requires a relatively precise positioning of the sensor unit and of the associated magnet or of the associated magnetizable element. Furthermore, the piston should not rotate during the opening and closing.

Preferably, the magnetic field sensor, in particular the Hall sensor, is therefore a two-dimensional (2D) sensor, even more preferably a three-dimensional (3D) sensor. In this way, a rotation of the piston can be identified and deviations in the positioning of the sensor unit can be identified. With the aid of the 3D sensor, a magnetic vector and the magnitude thereof can be determined.

Preferably, the valve unit comprises a control device which continuously evaluates positions of the piston, wherein the control device is configured to evaluate further positions during a movement of the piston in addition to a closed and an open state of the valve. In this way, the movement profile of the piston can be evaluated, for example it can be determined whether the valve is closing rapidly enough. Wear of the valve, in particular of the piston, can be identified at an early stage.

In preferred embodiments, the piston is fastened to the housing part in a releasable manner and so as to be movable relative to the housing part, as a result of which the housing part together with the piston and the sensor unit are jointly exchangeable. This facilitates the maintenance of the device, in particular of the blow-moulding device.

Preferably, the sensor unit is arranged without a housing in the receiving opening, wherein the housing part surrounds the sensor unit in a protective manner. This minimizes the space requirement of the sensor unit, which is advantageous in particular in the case of the confined conditions of a valve head of a blow-moulding device. In addition, the production costs are reduced.

In preferred embodiments, the sensor unit has an elongate shape, wherein the magnetic field sensor, in particular the Hall sensor, is arranged in an end region. The magnetic field sensor can thus be brought close to the magnet or close to the magnetizable element, such that low requirements can be placed on the mutual positioning of the two measurement elements.

Preferably, the sensor unit has an elongate base plate, wherein the magnetic field sensor, in particular the Hall sensor, is arranged in an end region of the base plate and wherein the base plate is received in the receiving opening. Preferably, the base plate runs along the common axis.

Preferably, the sensor unit is held in the receiving opening or in the housing part in an exchangeable manner.

Preferably, a plug is fixedly connected to the base plate at an end lying opposite to the end region, wherein the plug is accessible from the outside in the state when the base plate is mounted in the receiving opening. This facilitates the mounting and the exchanging of the sensor unit. In addition, a cable connection to a control device is simplified.

In preferred embodiments, the sensor unit is mounted in the end region thereof facing the piston. Preferably, in this regard, an O-ring is present. In other embodiments, the sensor unit is of such a shape that a bearing arrangement is unnecessary.

Preferably, the piston has a circular-cylindrical base body which defines a longitudinal central axis, wherein the common axis is the longitudinal central axis of the piston and wherein the magnetic field sensor, in particular the Hall sensor, and the magnet or the magnetizable element are arranged centrally with respect to the longitudinal central axis. This facilitates the measurement, particularly if the piston can rotate during the opening and closing of the valve.

Depending on the embodiment of the piston and its piston receptacle, the piston is rotationally fixed or rotatable in relation to the housing part. If said piston is rotatable, the magnetic field sensor, in particular the Hall sensor, and/or the magnet are/is preferably arranged centrally with respect to the axis of rotation of the piston, wherein the axis of rotation is preferably the longitudinal central axis. Preferably, the magnetic field sensor and the magnet are arranged centrally with respect to the axis of rotation or with respect to the longitudinal central axis. The same applies if, instead of a magnet, a magnetizable element is arranged in the piston.

Preferably, the entire sensor unit is arranged centrally with respect to the longitudinal central axis. Preferably, the elongate sensor unit runs, in terms of its longitudinal extent, along the common axis and even more preferably along the longitudinal central axis.

In other embodiments, the magnet and/or the magnetic field sensor are/is arranged eccentrically in order to obtain more information with regard to the rotation of the piston. This is the case in particular when using a 3D (three-dimensional) magnetic field sensor, in particular a 3D Hall sensor.

The valve unit and in particular the piston may be of different design. In particular, they may have the shape of known valve units and pistons. In a preferred embodiment, the housing part comprises a guide pin which projects into a cutout of the piston and wherein the magnetic field sensor, in particular the Hall sensor, is arranged in the guide pin. As a result, the piston is guided in an optimal manner in the region of the magnetic field sensor and of the magnet or of the magnetizable element. This facilitates the measurement.

The invention further comprises a valve unit
comprising a valve which comprises a movable piston for closing and opening the valve,
comprising a magnet or a magnetizable element and
comprising a sensor unit which comprises a magnetic field sensor, preferably a Hall sensor, for determining a position of the piston,
   wherein the magnet or the magnetizable element and the sensor unit are movable relative to one another by the movement of the piston. The sensor unit is arranged without a housing in a receiving opening in the valve unit, wherein the receiving opening surrounds the sensor unit in a protective manner.

This valve unit can be of extremely space-saving configuration. In addition, the magnetic field sensor, in particular the Hall sensor, can, as a result, be brought into close proximity to the magnet or to the magnetizable element, as a result of which a strong measurement signal is received.

The invention also comprises a valve unit
comprising a valve which comprises a movable piston for closing and opening the valve,
comprising a magnet or a magnetizable element and
comprising a sensor unit which comprises a magnetic field sensor, preferably a Hall sensor, for determining a position of the piston,
   wherein the magnet or the magnetizable element and the sensor unit are movable relative to one another by the movement of the piston. The magnetic field sensor is a 3D sensor with lateral and vertical sensor elements for measuring a three-dimensional vector of a magnetic flux density.

This valve unit allows a precise measurement even in the case of a rotating piston or in the case of a not precisely axial orientation of the magnetic field sensor, in particular of the Hall sensor, and of the magnet or of the magnetizable element. Furthermore, more information relating to the behaviour of the piston during the opening and closing can be obtained.

These mentioned valve units can be combined in any desired manner with the preferred embodiments mentioned in the text, without it being necessary for the features relating to the closed receiving opening or the evaluation of the further positions of the piston to also be present.

Preferably, all the described valve units can be calibrated by a teach in method. Deviations in the installation position of the sensor unit or of the piston can be recorded at the factory and stored on the sensor unit in a memory. In use, they are transmitted to the control device. As a result, correction data can be created and taken into account in the evaluation of the actual measured values. Defects, which are detected during the use of the valve, are preferably also stored in the memory of the sensor unit or in the control device and taken into account in further measurements.

Further embodiments are specified in the dependent patent claims.

### BRIEF DESCRIPTION OF THE DRAWINGS

Preferred embodiments of the invention are described below with reference to the drawings, which serve merely for elucidation and are not to be interpreted as restrictive. In the drawings:

FIG. 1 shows a schematic illustration of a housing block with process valves according to the invention of a blow-moulding machine;

FIG. 2 shows a cross section through a valve according to the invention in the open state according to a first embodiment;

FIG. 3 shows the valve according to FIG. 2 in the closed state;

FIG. 4 shows a view of a sensor unit according to the invention in a first embodiment;

FIG. 5 shows a perspective illustration of the sensor unit according to FIG. 4;

FIG. 6 shows a view of a sensor unit according to the invention in a second embodiment;

FIG. 7 shows a perspective illustration of the sensor unit according to FIG. 6;

FIG. 8 shows an illustration of part of the valve according to FIG. 3, illustrating pressure equalization lines and a control pressure line and illustrating the magnetic field lines;

FIG. 9 shows a cross section through a valve according to the invention in the closed state according to a second embodiment, and

FIG. 10 a cross section through an inventive valve in the open state according to a third embodiment.

Same parts are marked with the same reference signs.

### DESCRIPTION OF PREFERRED EMBODIMENTS

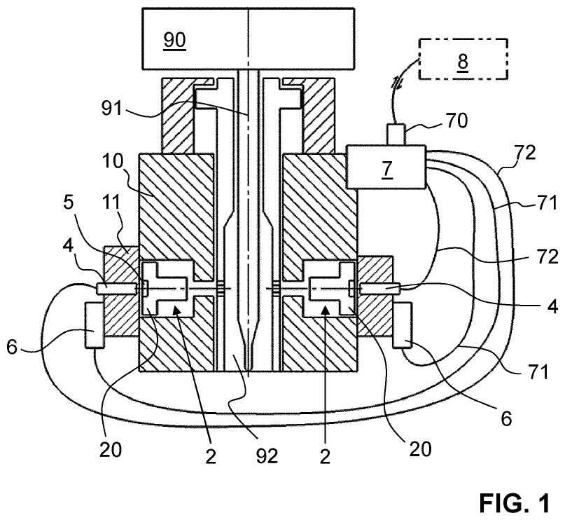

FIG. 1 shows a preferred area of application of the valve unit according to the invention. It concerns a housing block of a blow-moulding machine. The housing block forms a first housing part 10 with respect to the valve units. The housing part 10 comprises a through-bore 92 which is passed through by a stretching mandrel 91 connected to a stretching mandrel device 90. A blank of a body to be inflated, in particular of a PET bottle, can be arranged on or in the through-bore 92. Such blow-moulding machines are largely known in the prior art and are therefore not described further.

As mentioned in the introduction, they comprise a plurality of process valves which are actuated at different times in the course of the blow-moulding process in order to bring the blank into the desired shape by means of blowing air. In this view, two process valves are illustrated. They each comprise at least one pilot valve 6 in the form of a solenoid valve and a main valve in the form of a pneumatic piston valve. In this text, the main valve is referred to as valve 2.

A control device 7 is connected to the pilot valves 6 via pilot valve lines 71 in the form of cables. The control device 7 is also connected to a machine controller 8, as shown by means of the control line 70. Preferably, the control device 7 forms a unit which is separate from the machine controller 8. However, it may also be part of the machine controller 8.

The process valves and in particular their main valves may be identical and serve the same purpose or they may be of different configuration.

According to the invention, a sensor unit 4 is present for at least one valve 2, preferably for each valve 2. The sensor unit 4 is arranged in a second housing part 11. The second housing part 11 preferably forms a cover for a receiving opening in the first housing part 10, the valve 2 being arranged in said receiving opening. The at least one pilot valve 6 is preferably also arranged on or in the second housing part 11. For example, the second housing part 11 can be fastened to the first housing part 10 by means of screws 12, as can be seen in FIG. 3.

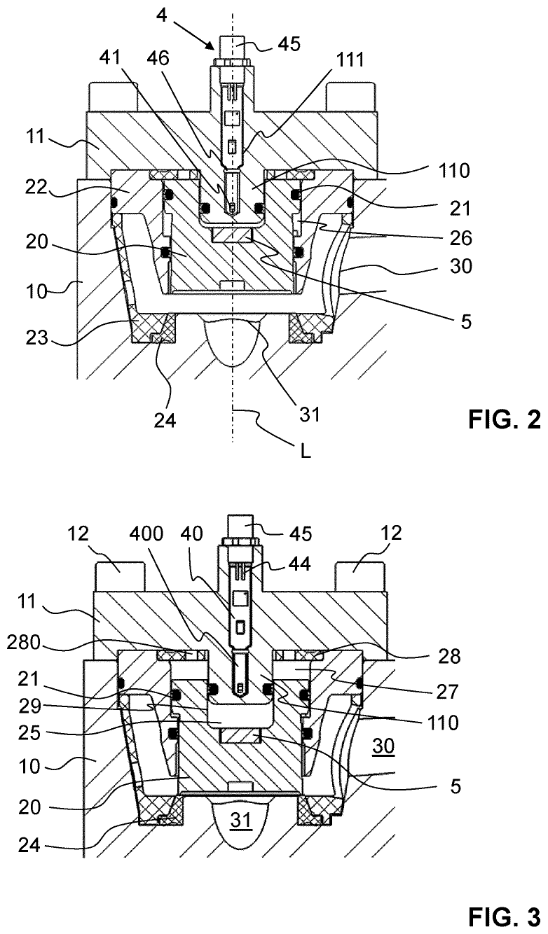

An exemplary embodiment of a valve 2 according to the invention is illustrated in FIGS. 2 and 3. The valve 2 comprises a piston 20 which is movably arranged in a cutout formed by the first and second housing part 10, 11. In this regard, a guide skirt 22, which holds the piston 20 on the second housing part 11 in a movable manner, is fastened to the second housing part 11 which forms a cover. Various seals 21 in the form of seal rings form a seal between the piston 20 and the second housing part 11 or the guide skirt 22. At least one further seal 21 forms a seal between the guide skirt 22 and the first housing part 10. The elements illustrated as small black areas in FIGS. 2 and 3 are such seals 21, even though not all of them are provided with the corresponding reference designation.

A hold-down means 23 is fastened or clamped in the first housing part 10 and holds an encircling seat seal 24 in position. In the closed state, the piston 20 pushes onto the seat seal 24 and thus closes a line between a process fluid inlet opening 30 and a process fluid outlet opening 31, as can be seen in FIG. 3. A stop ring 28 comprising a circular or punctiform opening 280 serves as upper stop of the piston 20. The piston 20 illustrated here comprises a central cutout 29 which is formed on that side of the piston which is opposite to the process fluid outlet.

A guide pin 110 arranged on the second housing part 11 engages into the cutout 29 of the piston 20. A circular chamber 25, the volume of which changes depending on the displacement position of the piston 20, is formed between the guide pin 110 and the bottom of the cutout 29 of the piston 20. A first annular chamber 26 is formed between the guide skirt 22 and the piston 20, and a second annular chamber 27 is formed between the piston and the second housing part 11.

The piston 20 comprises control surfaces in control spaces so that it can be opened and closed by means of a control pressure. The piston 20 is preferably pressure-balanced with respect to the process fluid and is thus preferably actuated exclusively by means of the control pressures. The control pressures are controlled by means of the at least one pilot valve. Such valves are known. The circular chamber 25 forms a first control space for a first control pressure and the annular first chamber 26 forms a second control space for a second control pressure.

The second annular chamber 27 is a pressure equalization chamber to which the process fluid is applied.

In other embodiments, the circular chamber 25 is the pressure equalization chamber. The first annular chamber 26 still forms the second control space and the second annular chamber 27 forms the first control space. The control lines and the pressure equalization line are correspondingly arranged at suitable locations.

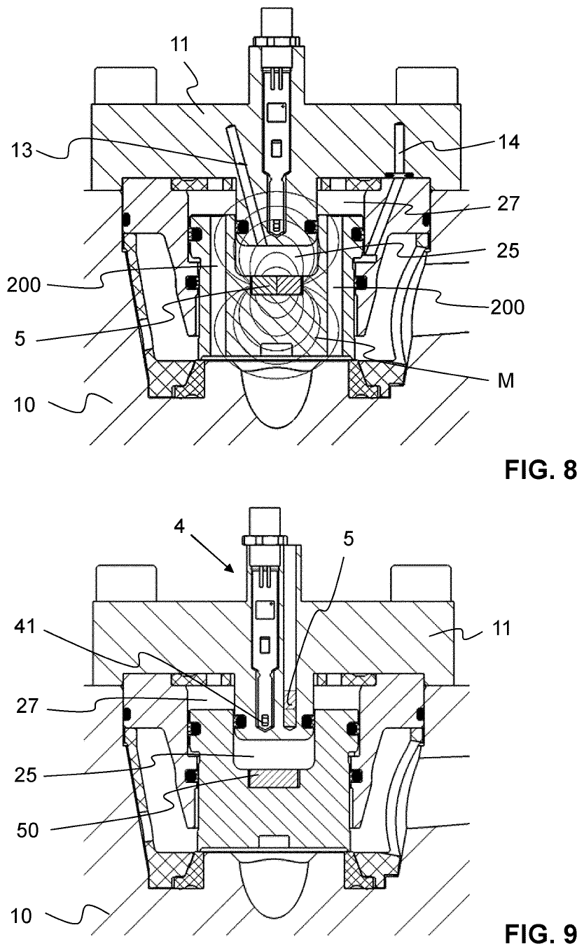

The associated first control line 13 and the associated second control line 14 for the control fluid, normally control air, which are used in the first exemplary embodiment are illustrated in FIG. 8. The associated pressure equalization lines 200 between the process fluid chamber, in the region between the process fluid inlet and the process fluid outlet, and the pressure equalization chamber 27 can also be seen in FIG. 8. Such a valve is described in the as yet unpublished European patent application 21 171 204.7.

The valve described here serves merely to illustrate the inventive concept. The valve 2 per se, i.e. the shape of the piston 20, the arrangements of the seals 21 and of the control spaces and of the pressure equalization chamber, may also be different. In particular, it is also possible to use valves of known type without guide skirt or hold-down means and with a differently shaped seal seat. The valve may also comprise a dedicated housing, such that parts of the valve block are not used for this purpose.

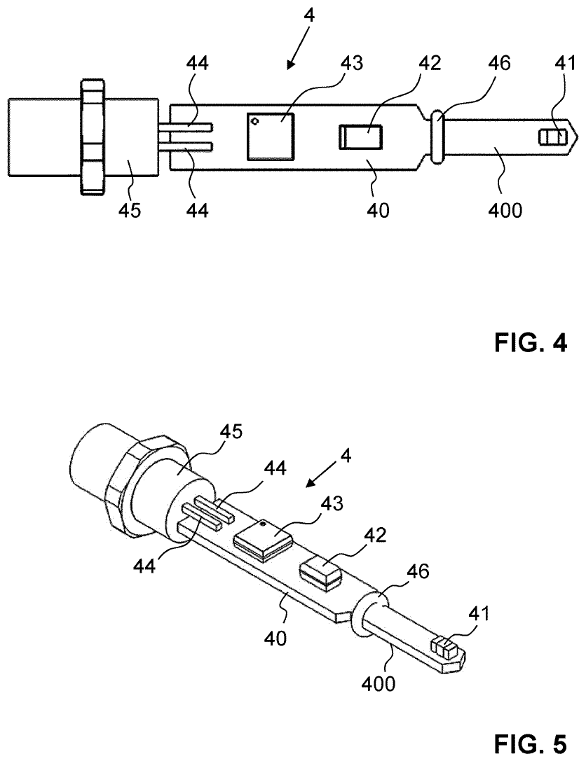

According to the invention, the valve 2 comprises a sensor unit 4. The sensor unit 4 is preferably configured in an elongate shape. It is introduced into, and held in, a receiving opening 111 in the second housing part 11. Preferably, the sensor unit 4 extends along a longitudinal central axis L of the piston 20. A magnetic field sensor, in this case a Hall sensor 41, is arranged in an end region 400 of the sensor unit 4, as can be seen in FIGS. 4 and 5. An O-ring 46, which separates the end region 400 from a preferably flat base plate 40, supports the sensor unit 4 in the second housing part 11, as can readily be seen in FIGS. 2 and 3. Instead of the Hall sensor, it is possible to use a different magnetic field sensor, for example a magneto-resistive sensor.

That end of the receiving opening 111 in the second housing part 11 which faces the piston is preferably of closed configuration. In this example, the housing part 11 is of one-part configuration and thus comprises a wall in this region. As a result, the sensor unit does not project into the circular chamber 25. The Hall sensor 41 is separated from a fluid in the circular chamber 25 and thus from the control fluid. By virtue of the encircling side wall of the housing part 11, said side wall being of closed configuration, the Hall sensor 41 is also separated from the second annular chamber 27 and the fluid thereof, in this case the process fluid.

At the opposite end thereof, the sensor unit 4 comprises a plug 45 which is soldered onto the base plate 40 by means of a plug connection 44. The plug 45 projects from the second housing part 11 and serves, on the one hand, as second bearing arrangement and, on the other hand, for connection to the above-mentioned control device 7. The sensor unit 4 is preferably arranged in the second housing part 11 in a releasable manner. Preferably, the second housing part 11 is connected to the first housing part 10 in a releasable manner. Preferably, the second housing part 11 together with the piston 20 and the guide skirt 22 is removable from the first housing part 10.

A magnet 5 is arranged in the piston 20. It is preferably a permanent magnet. It is preferably located in a common axis with respect to the sensor unit, wherein the axis extends along the movement direction of the piston during the closing and opening of the valve. This axis preferably corresponds to the longitudinal central axis L. In this example, the magnet 5, in particular the permanent magnet, is a bar magnet. The resulting magnetic field lines M can readily be seen in FIG. 8. Said magnetic field lines cross the sensor unit 4 and thus the Hall sensor 41 in each case perpendicularly.

Instead of the Hall sensor 41, it is also possible for a different magnetic field sensor to be arranged in the above-described sensor unit and in the sensor units described below.

In alternative embodiments, a magnetizable element 50 is located at the location of the magnet 5, and the magnet 5, in particular a permanent magnet or an electromagnet, is arranged in the second housing part 11, preferably also in the guide pin 110. The housing part 11 preferably comprises a corresponding receiving bore which is accessible from the outside and which is of closed configuration in relation to the circular chamber, in this case the first control space 25. This is illustrated in FIG. 9, the magnet 5 being a bar-like or plate-like permanent magnet in the illustrated example. Another magnet, for example an electromagnet, can also be arranged at the same location or at a different location.

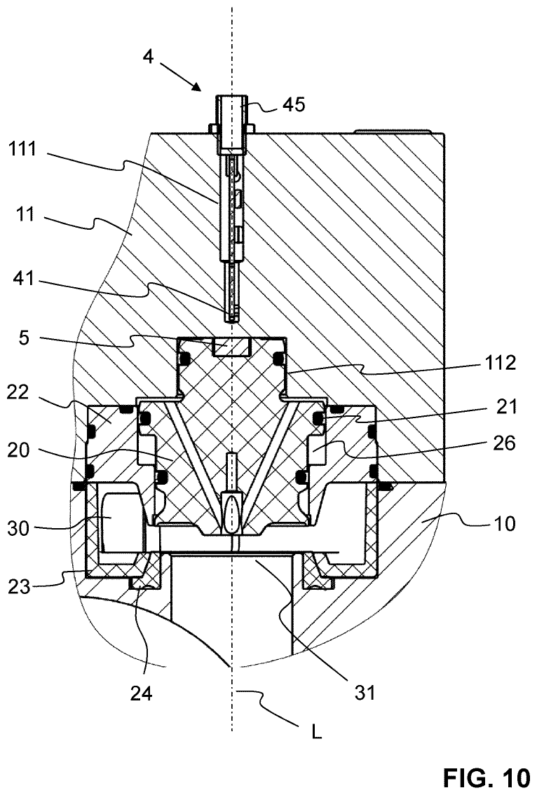

In alternative embodiments, guide pins are not present. In some embodiments, the second housing part 11 ends with a flat surface against which the piston 2 rests in the open state. In other embodiments, the second housing part 11 comprises a recess 112 into which the piston 2 penetrates. This can be seen in FIG. 10.

As can be seen in FIGS. 4 and 5, further elements are also arranged on the base plate 40. A memory 42 is preferably present, in order to locally store measured values, but also correction values. An electronics unit 43 is preferably present, in order to operate the magnetic field sensor and to forward the measured values to the control unit 7. The magnetic field sensor is preferably also a Hall sensor or one of the above-mentioned sensors.

The sensor unit 4 illustrated in FIGS. 4 and 5 is preferably configured without a housing and is, in the illustrated form, plugged directly into the receiving opening 111 in the second housing part 11. That is to say that the second housing part 11 forms the protective housing for the sensor unit 4.

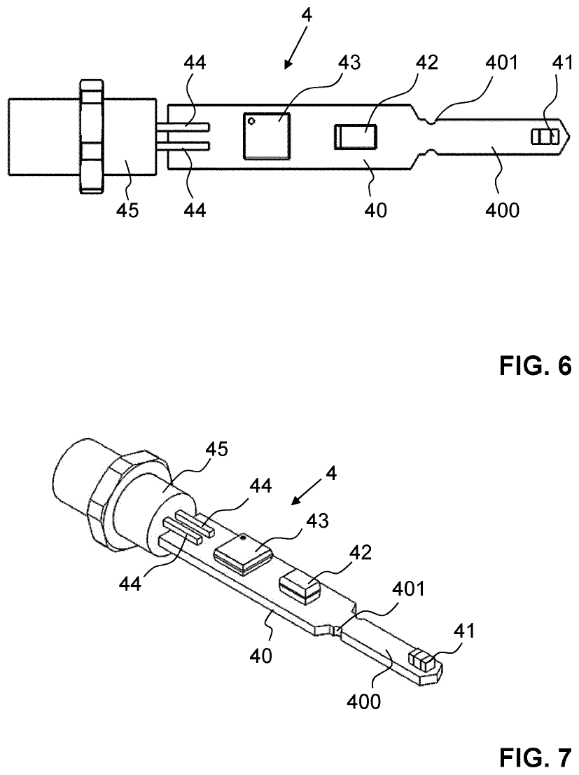

In FIGS. 6 and 7, the sensor unit 4 is illustrated without an O-ring at the tapered portion 401. It can also be used in this manner. If said sensor unit is not intended to be removable again, it can also be encapsulated in the receiving opening 111 or fixed in some other way.

The valve unit according to the invention permits precise monitoring of the piston and thus early identification of ageing.

LIST OF REFERENCE DESIGNATIONS

| | | | |
|---|---|---|---|
| 10 | First housing part | 40 | Base plate |
| 11 | Second housing part | 400 | End region |
| 110 | Guide pin | 401 | Tapered portion |
| 111 | Receiving opening | 41 | Hall sensor |
| 112 | recess | 42 | Memory |
| 12 | Screws | 43 | Electronics unit |
| 13 | First control line | 44 | Plug connection |
| 14 | Second control line | 45 | Plug |
| 2 | Valve | 46 | O-ring |
| 20 | Piston | 5 | Magnet |
| 200 | Pressure equalization line | 50 | Magnetizable element |
| 21 | Seal | 6 | Pilot valve |
| 22 | Guide skirt | 7 | Control device |
| 23 | Hold-down means | 70 | Control line |
| 24 | Seat seal | 71 | Pilot valve line |
| 25 | Annular chamber | 72 | Sensor line |
| 26 | Annular chamber | 8 | Machine controller |
| 27 | Circular chamber | 90 | Stretching device |
| 28 | Stop ring | 91 | Stretching mandrel |
| 280 | Opening | 92 | Through-bore |
| 29 | Cutout | L | Longitudinal central axis |
| 30 | Process fluid inlet opening | | |
| 31 | Process fluid outlet opening | | |
| 4 | Sensor unit | | |

1. A valve unit comprising
a valve which comprises a movable piston for closing and opening the valve,
a magnet or a magnetizable element and
a sensor unit (4) which comprises a magnetic field sensor for determining a position of the piston,
wherein the magnet or the magnetizable element and the sensor unit are movable relative to one another by the movement of the piston,
wherein
the valve unit comprises a control device which continuously evaluates positions of the piston, and wherein the control device is configured to evaluate further positions during a movement of the piston (20) in addition to a closed and an open state of the valve.

2. The valve unit according to claim 1 wherein the magnetic field sensor is a Hall sensor.

3. The valve unit according to claim 1 wherein the sensor unit is arranged in a receiving opening in the valve unit, said receiving opening being of closed configuration in relation to a space into which the piston penetrates during its movement.

4. The valve unit according to claim 1 wherein the magnet or the magnetizable element is arranged in the piston and the sensor unit is arranged in a positionally fixed manner.

5. The valve unit according to claim 1, wherein the sensor unit is arranged in a housing part of the valve unit and wherein the receiving opening is of open configuration towards an outer side for the purpose of introducing the sensor unit.

6. The valve unit according to claim 1 wherein the magnetic field sensor is a 2D sensor or a 3D sensor.

7. The valve unit according to claim 1, wherein the sensor unit comprises an elongate base plate, wherein the magnetic field sensor is arranged in an end region of the base plate and wherein the base plate is received in the receiving opening.

8. A valve unit comprising
a valve which comprises a movable piston for closing and opening the valve,
a magnet or a magnetizable element and
a sensor unit which comprises a magnetic field sensor for determining a position of the piston,
wherein the magnet or the magnetizable element and the sensor unit are movable relative to one another by the movement of the piston,
wherein the sensor unit is arranged in a receiving opening in the valve unit, said receiving opening being of closed configuration in relation to a space into which the piston penetrates during its movement.

9. The valve unit according to claim 8, wherein the magnet or the magnetizable element is arranged in the piston and the sensor unit is arranged in a positionally fixed manner.

10. The valve unit according to claim 8, wherein the sensor unit is arranged in a housing part of the valve unit and wherein the receiving opening is of open configuration towards an outer side for the purpose of introducing the sensor unit.

11. The valve unit according to claim 10, wherein the piston is fastened to the housing part in a releasable manner and so as to be movable relative to the housing part, as a result of which the housing part together with the piston and the sensor unit are jointly exchangeable.

12. The valve unit according to claim 10, wherein the housing part comprises a guide pin which projects into a cutout of the piston and wherein the magnetic field sensor is arranged in the guide pin.

13. The valve unit according to claim 8, wherein the magnetic field sensor and the magnet or the magnetizable element are arranged spaced apart from one another along a common axis, wherein the common axis extends along the movement direction of the piston during the opening and closing of the valve.

14. The valve unit according to claim 13, wherein the receiving opening has a longitudinal direction which extends along the common axis.

15. The valve unit according to claim 8, wherein the magnetic field sensor is a 2D sensor or a 3D sensor.

16. The valve unit according to claim 8, wherein the sensor unit is arranged without a housing in the receiving opening, wherein the housing part surrounds the sensor unit in a protective manner.

17. The valve unit according to claim 8, wherein the sensor unit comprises an elongate base plate, wherein the magnetic field sensor is arranged in an end region of the base plate and wherein the base plate is received in the receiving opening.

18. The valve unit according to claim 17, wherein a plug is fixedly connected to the base plate at an end lying opposite to the end region, wherein the plug is accessible from the outside in the state when the base plate is mounted in the receiving opening.

19. The valve unit according to claim 8, wherein the sensor unit comprises an O-ring, by means of which it is mounted in the receiving opening.

20. The valve unit according to claim 8, wherein the piston has a circular-cylindrical base body which defines a longitudinal central axis, wherein the common axis is the longitudinal central axis of the piston and wherein the magnetic field sensor and the magnet or the magnetizable element are arranged centrally with respect to the longitudinal central axis.

21. The valve unit comprising a valve according to claim 8, wherein the valve unit comprises a control device which continuously evaluates positions of the piston, wherein the control device is configured to evaluate further positions during a movement of the piston in addition to a closed and an open state of the valve.

22. A valve unit
comprising a valve which comprises a movable piston for closing and opening the valve,
having a magnet or a magnetizable element and
comprising a sensor unit which comprises a magnetic field sensor for determining a position of the piston,
wherein the magnet or the magnetizable element and the sensor unit are movable relative to one another by the movement of the piston,
wherein the sensor unit is arranged without a housing in a receiving opening in the valve unit, and wherein the receiving opening surrounds the sensor unit in a protective manner.

23. A valve unit
comprising a valve which comprises a movable piston for closing and opening the valve,
comprising a magnet or a magnetizable element and
comprising a sensor unit which comprises a magnetic field sensor for determining a position of the piston,
wherein the magnet or the magnetizable element and the sensor unit are movable relative to one another by the movement of the piston,
wherein the magnetic field sensor is a 3D sensor with lateral and vertical sensor elements for measuring a three-dimensional vector of a magnetic flux density.

24. The valve unit according to claim 8 wherein the magnetic field sensor is a Hall sensor.

25. The valve unit according to claim 22 wherein the magnetic field sensor is a Hall sensor.

26. The valve unit according to claim 23 wherein the magnetic field sensor is a Hall sensor.
